(19) United States
(12) Patent Application Publication
(10) Pub. No.: US 2016/0170003 A1
(43) Pub. Date: Jun. 16, 2016

(54) SUN LIGHT OPTICAL ALIGNING APPARATUS

(71) Applicant: James Howard BUSHONG, JR., Collegeville, PA (US)

(72) Inventor: James Howard Bushong, Collegeville, PA (US)

(21) Appl. No.: 14/900,815

(22) PCT Filed: Jul. 1, 2014
(86) PCT No.: PCT/US14/44987

§ 371 Date: Dec. 22, 2015

Related U.S. Application Data
(60) Provisional application No. 61/957,437, filed on Jul. 2, 2013.

(51) Int. Cl. G01S 3/786

(52) U.S. Cl. CPC G01S 3/7861

(57) ABSTRACT

The present invention is a solar light aligning apparatus that uses optics and optical physics to align sun light. The solar light aligning apparatus can determine the tilt of any planar surface such that the planar surface is perpendicular or substantially perpendicular to the sun. The apparatus can be used as a guide to adjust the tilt angle of solar energy collection apparatus such as solar photovoltaic or solar thermal energy collectors. The solar light aligning apparatus can determine the optimal tilt angle for high efficiency solar energy collection on a daily basis, for any latitude, seasonal movement of the sun, east-west orientation of solar energy collector, and pitch of the surface upon which solar energy collectors are mounted.

### CROSS-REFERENCE TO RELATED APPLICATIONS

The present PCT patent application claims priority benefit of the U.S. provisional application for patent 61/957,437, dated 2 Jul. 2013, “Sun Light Optical Aligning Apparatus” under 35 U.S.C. 119(e). The contents of this related provisional patent application are incorporated herein by reference to the extent that such subject matter is not inconsistent herewith or limiting hereof.

### FIELD OF THE INVENTION

The present invention relates generally to an apparatus that uses optics and optical physics to align sun light. The apparatus can be used as a guide to adjust the tilt angle of solar energy collection apparatus such as solar photovoltaic or solar thermal energy collectors. The apparatus can determine the optimal tilt angle for high efficiency solar energy collection on a daily basis, for any latitude, seasonal movement of the sun, east-west orientation of solar collector, and pitch of the surface upon which solar energy collectors are mounted.

### BACKGROUND ART

Solar energy systems for photovoltaic electric generation and thermal energy are well known, with both types of systems utilizing some type of solar light collector to absorb solar energy. Frequently, solar energy collectors utilize transparent or semi-transparent covers, referred to in the industry as glazings or cover glazings. It is desirable to maximize the energy production output of any solar energy system, in order to maximize the use of the solar energy collector. However, the maximum energy production can only be achieved by orienting the tilt angle of the solar collector to maximize solar energy absorption area while minimizing reflections for the primary solar light accepting face of the solar collector. The available solar energy for collection is a direct function of the area of collector available for solar light absorption; when the primary solar light accepting face of the solar collector is perpendicular to the sun light rays, the area of solar energy collector available for solar light absorption can be maximized. Additionally, solar light impacting onto transparent or semi-transparent faces of solar energy collectors obeys the Fresnel laws of reflection; reflections can be very low when the sun light hitting the collector is as close as possible to perpendicular relative to the surface of the solar energy collector, and thereby transmittance of solar light into the solar energy collector for conversion to useful energy can be very high. Therefore for both maximizing the area for solar energy absorption and for high transmittance of sun light into the solar energy collector for absorption, it is desirable that the primary sun light accepting face of the solar energy collector be as close to perpendicular as practical to the rays of sun light impacting onto the primary sun light accepting face of the solar energy collector. Since the angle at which sun light rays reach a specific point on the earth will vary for each day of the year due to the seasonal north-south change in the tilt of the earth, the optimal angle for a solar energy collector at that specific point on earth will also vary for each day of the year. The optimal tilt angle to maximize solar energy collector area available for solar light absorption with very low solar light reflections will also vary depending on the latitude at which the solar collectors are located and the east-west orientation of the collector, again due to the angle of the sun changing relative to the primary sun light accepting face of the solar energy collector. Therefore, each specific point on earth will have an optimal tilt angle at which to orient a solar collector that also depends on the latitude at which the solar energy collector is located and the east-west orientation of the solar energy collector, for each day of the year. Further complexities occur if the land at which the solar collectors is placed is not flat; an angled surface such as roof pitch or land pitch on which the solar collector is mounted introduces another variable in the angle of the sun relative to the primary sun light accepting face of the solar energy collector, and therefore introduces another variable as to how to orient the solar collectors to obtain the optimal tilt angle. Although computer programs and trigonometry have been utilized to recommend the optimal collector tilt angle depending on latitude, east-west orientation of the collector, and the day of the year to account for the seasonal movement of the sun, such methods can be complex and cumbersome, and cannot easily account for solar collectors mounted on surfaces (e.g. roofs or land) that are not perfectly flat. For solar energy collectors, the tilt angle is conventionally defined as the angle between the back of the collector and level; if the ground is not perfectly level, computer programs that recommend optimal tilt angle can provide a result that is difficult to determine how a real-world solar collector on non-level ground is supposed to be tilted.

### SUMMARY OF INVENTION

In consideration of the complex, cumbersome nature of computer programs, and the difficulty computer programs have in providing accurate calculations for solar collectors that are not mounted on a level surface, and difficulty in interpreting the computer program calculated results for optimal tilt angle for solar collectors that are not mounted on a level surface or that have no clear reference to level, the present invention provides an optical aligning device that easily enables any solar energy collection apparatus to determine the optimal tilt angle for any day of the year, for any latitude, for any east-west solar collector orientation, and for any pitch in the surface upon which the solar energy collection apparatus is mounted. The present invention is a solar light optical aligning apparatus that uses a Fresnel lens as the sun-facing side of a housing, and the housing contains a target upon which the Fresnel lens focuses the sunlight such that the image of the sun produced by the Fresnel lens is focused on the target region when the face of the Fresnel lens is perpendicular or substantially perpendicular to the sun. The tilt of the Fresnel lens face of the solar light optical aligning apparatus then represents an optimal tilt angle such that any planar object that is parallel to the tilt of the Fresnel lens face that resulted in a substantially perpendicular alignment between the face of the Fresnel lens and the sun, will also result in the planar object that is parallel to the tilt of the Fresnel lens being substantially perpendicularly aligned with the sun. The solar light aligning apparatus of the present invention can have adjustment mechanisms to enable adjustment of the tilt angle and east to west orientation of the solar light optical aligning apparatus such that the optimal tilt angle that focuses the sunlight onto the target can easily be found at any specific point on earth on any day, at any latitude, at any east-west orientation of a solar energy collection apparatus, and any pitch upon which a solar energy collector apparatus is mounted. The solar energy collector tilt angle is simply adjusted to match the tilt angle that resulted in the sun light hitting the target within the housing of the solar light optical aligning apparatus of the present invention. Alternatively, the solar light optical aligning apparatus of the present invention is mounted directly to the same framing device that the solar energy collectors are mounted to, with the Fresnel lens face of the solar light optical aligning apparatus being parallel to and ideally as close to flush mounted as practical with the primary sun light accepting face of the solar energy collector. The tilt angle of the solar energy collector framing device is then simply adjusted until the sun light is aligned with the target within the housing of the solar light optical aligning apparatus of the present invention. The primary sun light accepting face of the solar energy collectors will then be substantially perpendicular to the sun, resulting in the desired high solar energy collection efficiency with high collection area for sun light absorption and high transmittance of sun light into the solar energy collector. The solar light optical aligner of the present invention can then provide the optimal tilt angle for the solar energy collectors for high efficiency solar energy collection for any latitude, for any day of the year at any location, for any east to west orientation of solar energy collector, and for any pitch upon the surface at which the solar collectors are mounted. In fact with the present invention, a reference to “level” with respect to tilt angle is irrelevant; the primary sun light accepting face of the solar energy collector needs only be parallel with the Fresnel lens face of the solar light optical aligner apparatus when the solar light optical aligner apparatus is oriented such that the sun light is focused on the target within the housing of the solar light optical aligner apparatus. The present invention therefore enables any solar energy collection apparatus to be adjusted for high efficiency solar light absorption by maximizing the solar energy collector area available for solar energy absorption with very high transmittance of sun light into the collector by determining what is hereafter referred to simply as “tilt relative to the sun”, or simply “tilt” or “tilt angle”, as opposed to “tilt angle relative to level” that has conventionally been utilized for solar energy collectors. Thus the complexities and ambiguities with the conventional methods that had used the terms “level”, and required knowing what exactly “level” was, and “tilt angle relative to level”, can be completely eliminated with the solar light optical aligner apparatus of the present invention. Additionally, the pitch of the surface upon which a solar energy collector is mounted will also become irrelevant when the tilt alignment is performed with the solar light optical aligner of the present invention, because the optimal tilt becomes only a function of the alignment between the sun and the solar optical aligner, and subsequently to matching the tilt of the solar optical aligner such that the primary sun light accepting face of the solar energy collector is parallel to the face of the solar optical aligner.

A useful application is then to obtain optimal amount of solar energy available for absorption for a solar energy collector at any day of the year at any latitude, for any east-west orientation of solar energy collector, and for any pitch in the surface at which the solar collectors are mounted. The apparatus of the present convention can also be utilized intermittently to adjust the tilt of the solar energy collectors; for example, a once per month tilt adjustment relative to the sun can be utilized, or a once every 3 month tilt adjustment relative to the sun can be utilized, or a once every 6 month tilt adjustment relative to the sun can be utilized. The actual adjustment frequency of the tilt relative to the sun is at the discretion of the owners or operators of the solar energy collectors for solar collectors that require a manual tilt adjustment; the present invention simply provides a superior method to easily adjust the tilt of the solar energy collector relative to the sun's position to achieve high solar energy collection by maximizing solar collector area with very high solar light transmittance into the solar energy collector by aligning the solar energy collector substantially perpendicular to the rays of sun light on any particular day at any particular location on earth, for any pitch in the surface upon which the solar energy collectors are mounted, and for any east-west orientation of the solar energy collector. As used herein, the term “substantially perpendicular” refers to sun light rays that impact the Fresnel lens face of the solar optical aligner and the primary sun light accepting face of a solar energy collector that are within a range of perpendicular plus or minus about 20 degrees relative to the east to west centerline axis of the Fresnel lens face of the solar optical aligner and the primary sun light accepting face of a solar energy collector (e.g. 70 to 110 degrees) during an approximate 1 to 2 hour window of maximum solar energy (solar radiation power density) for the particular day of the year, location on earth, and east to west orientation of the solar energy collector at that particular location on earth. As used herein, the east to west centerline axis of the Fresnel lens face of the solar optical aligner of the present invention and the east to west centerline axis of the primary sun light accepting face of a solar energy collector is the axis that bisects the dead center point of the Fresnel lens face of the solar light optical aligner and the primary sun light accepting face of the solar energy collector and that corresponds to the east to west movement of the sun across the sky of earth during the 1 to 2 hour window of maximum solar energy radiation (solar radiation power density) for the particular day of the year, location on earth, and east to west orientation of the solar energy collector at that particular location on earth. The convention used for the angle of sun light impacting onto the Fresnel lens face of the solar light optical aligner of the present invention and the primary sun light accepting face of the solar energy collector is that for example 70 degrees relative to the east to west centerline axis of the Fresnel lens face of the solar light optical aligner and the primary sun light accepting face of the solar energy collector is 20 degrees from the position of the sun earlier in the day relative to the perpendicular 90 degree alignment relative to the east to west centerline axis, and for example 110 degrees relative to the east to west centerline axis of the Fresnel lens face of the solar light optical aligner and the primary sun light accepting face of the solar energy collector is 20 degrees from the position of the sun later in the day relative to the perpendicular 90 degree alignment relative to the east to west centerline axis. The plus or minus 20 degrees from perpendicular along the east to west centerline axis of the Fresnel lens face of the solar optical aligner allows for flexibility in the time of day at which the tilt of the solar light optical aligner, and subsequently the tilt of the solar energy collector, is evaluated to account for the east to west movement of the sun during the day. By performing the alignment at some time during the approximate 1 to 2 hour window of peak solar energy (solar radiation power density) for the specific location, east to west orientation of a solar energy collector, and time of year, then the tilt alignment applied to the solar energy collector will allow for high solar energy collector area exposure and high transmittance of light into the collector by resulting in the primary sun light accepting face of the solar energy collector being substantially perpendicular to the sun for that particular location, time of year, and east to west orientation of the solar energy collector. By aligning a solar energy collector that has a fixed east to west orientation, but an adjustable tilt, such that the primary sun light accepting face of the solar energy collector is parallel to the face of the Fresnel lens of the solar light optical aligner of the present invention when the image of the sun produced by the Fresnel lens hits the target region within the housing of the solar light optical aligner of the present invention during the approximate 2 hour window of maximum solar energy (solar radiation power density) for the particular day of the year, location on earth, and east to west orientation of the solar collector, the daily energy output for that particular collector can be substantially maximized. An alternative is to utilize an automated sun tracking system, wherein the automated sun tracking system receives a signal from the solar light optical aligner apparatus of the present invention. For example, a photon-sensitive detector located at the target in the solar optical aligner apparatus of the present invention can detect the tilt relative to the sun that provides the maximum photon energy received, and send a signal to an automated sun tracking system to adjust the tilt relative to the sun accordingly. When the apparatus of the present invention is utilized in this manner with an automated sun tracking system, the solar light optical aligner has both east-west adjustment to account for the movement of the sun during the day, as well as north-south adjustment to account for the seasonal movement of the sun. The solar light optical aligner can also conveniently be mounted directly to the solar collector track mounting system, so that the Fresnel lens face of the solar light optical aligner is parallel and as flush as practical to the primary sun accepting face of the solar collector; when mounted in this manner, the east-west and north-south orientation that produces the most photon energy at the target receiver in the solar optical aligner will also result in the most photon energy to the solar collectors. Alternatively the solar optical aligner can have its own mounting system that enables automatic east-west and north-south adjustment to locate the optimal orientation for maximum photon energy hitting the target receiver, and then the target receiver within the solar optical aligner sends a signal to a control system that operates the automated sun tracking system to orient the solar collectors accordingly. When the solar optical aligner of the present invention is utilized in this manner with an automated solar tracking system, the energy output throughout the entire day can be maximized.

### BRIEF DESCRIPTION OF DRAWINGS

FIG. 1 shows a side view of an example of the solar light optical aligner of the present invention. Reference numeral 1 is pointing to the face of the solar light optical aligner that is facing the sun and is referred to herein as the top face, and the top face is a Fresnel lens, Reference numeral 2 is pointing to the bottom face of the housing that is opposite to the Fresnel lens face of the solar light optical aligner, Reference numeral 3 is pointing to one sidewall of the housing of the solar light optical aligner, and Reference numeral 4 is pointing to another sidewall of the housing of the solar light optical aligner.

FIG. 2 shows a top view of the sun light facing side of an example of the solar light optical aligner, and Reference 1 shows that this top face is a square shaped Fresnel lens with height of Reference 2 equal to width of Reference 3.

FIG. 3 shows a 3-dimensional top and side view of an example of the solar light optical aligner, and Reference 1 points to the top sun facing side that is a Fresnel lens, and Reference 2 is pointing to the bottom side of the housing of the solar light optical aligner, and Reference 3 is pointing to a side face of the housing that can be for example transparent or open to the air so that the image of the sun produced by the Fresnel lens can easily be viewed, and Reference 4 is pointing to another side face of the solar light optical aligner.

FIG. 4 shows a top view of the bottom face of the housing of an example of the solar light optical aligner as would be observed inside the housing of the solar optical aligner with the top sun light facing Fresnel lens removed, with Reference 1 pointing to the bottom face of the housing, and Reference 2 is pointing to the area along the bottom face of the housing that represents the target region for the image of the sun produced by the Fresnel lens to align within in order for the face of the Fresnel lens to be substantially perpendicular to the sun, and Reference 3 is referring to the north to south height of the target region upon which the Fresnel lens produced image of the sun is aligned within in order for the face of the Fresnel lens to be substantially perpendicular to the sun, and Reference 4 is referring to the width of the target region upon which the Fresnel lens produced image of the sun is aligned within in order for the east to west centerline of the Fresnel lens to be substantially perpendicular to the sun for an approximate 1 to 2 hour window of east to west movement of the sun across the sky, and Reference 5 is referring to a circular region that represents the image of the sun that would be produced by the Fresnel lens when the sun is perpendicular to the face of the Fresnel lens.

FIG. 5 shows a top view of the bottom face of the housing of an example of the solar light optical aligner as would be observed inside the housing of the solar optical aligner with the top sun light facing Fresnel lens removed, with Reference 1 pointing to the bottom face of the housing, and Reference 2 is pointing to the area on the bottom face of the housing that represents the target region for the image of the sun produced by the Fresnel lens to align within in order for the face of the Fresnel lens to be substantially perpendicular to the sun, and Reference 3 is referring to the north to south height of the target region upon which the Fresnel lens produced image of the sun is aligned in order for the face of the Fresnel lens to be substantially perpendicular to the sun, and Reference 4 is referring to the width of the target region upon which the Fresnel lens produced image of the sun is aligned within in order for the east to west centerline of the Fresnel lens to be substantially perpendicular to the sun for an approximate 1 to 2 hour window of east to west movement of the sun across the sky, and Reference 5 is referring to a circular region that represents the image of the sun that would be produced by the Fresnel lens when the sun is perpendicular to the face of the Fresnel lens.

FIG. 6 shows a 3-dimensional top and side view of an example of the solar light optical aligner, with Reference 1 pointing to the sun light facing top side that is a Fresnel lens, and Reference 2 pointing to a side face of the housing of the solar light optical aligner and can be a transparent side or open to the air side to enable easy viewing of the image of the sun produced by the Fresnel lens inside the housing, and Reference 3 refers to the back wall of the housing, and Reference 4 is pointing to the region of the bottom face of the housing that represents the target region for the image of the sun produced by the Fresnel lens to align within in order for the east to west centerline of the Fresnel lens to be substantially perpendicular to the sun for an approximate 1 to 2 hour window of east to west movement of the sun across the sky, and Reference 5 is referring to a circular region that represents the image of the sun that would be produced by the Fresnel lens when the sun is perpendicular to the face of the Fresnel lens.

FIG. 7 shows a 3-dimensional top and side view of an example of the solar light optical aligner, with Reference 1 pointing to the sun light facing top side that is a Fresnel lens, and Reference 2 pointing to a side face of the housing of the solar light optical aligner and can be a transparent side or open to the air side to enable easy viewing of the image of the sun produced by the Fresnel lens inside the housing, and Reference 3 refers to the back wall of the housing, and Reference 4 is pointing to a target region for the image of the sun produced by the Fresnel lens to align within in order for the east to west centerline of the Fresnel lens to be substantially perpendicular to the sun for an approximate 1 to 2 hour window of east to west movement of the sun across the sky, and Reference 5 is referring to a circular region that represents the image of the sun that would be produced by the Fresnel lens when the sun is perpendicular to the face of the Fresnel lens, and Reference 6 is a support structure that enables the target of Reference 4 to be suspended in a region that is between the top face of Reference 1 and the back face of Reference 3.

FIG. 8 shows a top view of the bottom face of the housing of an example of the solar light optical aligner as would be observed inside the housing of the solar optical aligner with the top sun light facing Fresnel lens removed, with Reference 1 pointing to the bottom face of the housing, and Reference 2 is pointing to a target that can measure photon energy and send an output signal to for example an automated solar tracking system, and Reference 3 is a circular region that represents the image of the sun that would be produced by the Fresnel lens when the sun is perpendicular to the face of the Fresnel lens.

FIG. 9 shows a side view of an example of the solar light optical aligner, with Reference 1 pointing to the sun light facing top side that is a Fresnel lens, and Reference 2 pointing to a side face of the housing of the solar light optical aligner and can be a transparent side or open to the air side to enable easy viewing of the image of the sun produced by the Fresnel lens inside the housing, and Reference 3 refers to the back wall of the housing, and Reference 4 is pointing to a target for the image of the sun produced by the Fresnel lens to align within in order for the face of the Fresnel lens to be perpendicular to the sun, and Reference 5 is a support structure that enables the target of Reference 4 to be suspended in a region that is between the top face of Reference 1 and the back face of Reference 3, and Reference 6 refers to rays of sun light impacting onto the Fresnel lens face of Reference 1, and Reference 7 refers to the angle between the Fresnel lens face and the rays of sun light, and Reference 8 refers to a perpendicular angle between the sun light rays and the face of the Fresnel lens that would produce the image of the sun onto the target of Reference 4.

FIG. 10 shows a side view of an example of the solar light optical aligner, with Reference 1 pointing to the sun light facing top side that is a Fresnel lens, and Reference 2 pointing to a side face of the housing of the solar light optical aligner and can be a transparent side or open to air side to enable easy viewing of the image of the sun produced by the Fresnel lens inside the housing, and Reference 3 refers to the back wall of the housing, and Reference 4 is pointing to a target for the image of the sun produced by the Fresnel lens to align within in order for the face of the Fresnel lens to be perpendicular to the sun, and Reference 5 is a support structure that enables the target of Reference 4 to be suspended in a region that is between the top face of Reference 1 and the back face of Reference 3, and Reference 6 refers to rays of sun light impacting onto the Fresnel lens face of Reference 1, and Reference 7 refers to the angle between the Fresnel lens face and the rays of sun light, and Reference 8 refers to a perpendicular angle between the sun light rays and the face of the Fresnel lens that would produce the image of the sun onto the target of Reference 4, and Reference 9 is a side view of the primary sun light accepting face of a solar energy collector, and Reference 10 refers to rays of sun light impacting onto the primary sun light accepting face of a solar energy collector, and Reference 11 refers to the angle between the primary sun light accepting face of a solar energy collector and the rays of sun light, and Reference 12 refers to a perpendicular angle between the sun light rays and the face of the primary sun light accepting face of a solar energy collector and wherein the rays of sun light are perpendicularly aligned to the primary sun light accepting face of a solar energy collector when the rays of sun light have been perpendicularly aligned to the face of the Fresnel lens by the solar light optical aligner as long as the face of the Fresnel lens shown by line segment A̅B̅ is parallel to the primary sun light accepting face of the solar energy collector shown by line segment D.

FIG. 11 shows the sun light facing top side for the primary sun light accepting face of a solar energy collector as Reference 1, mounted in a framing shown as Reference 2, with Reference 3 pointing to the sun light facing top side that is a Fresnel lens of an example of the solar light optical aligner of the present invention shown as Reference 4, and the solar light optical aligner is also mounted to the framing of Reference 2 such that the face of the Fresnel lens of Reference 3 is parallel to, and preferably flush with, the primary sun light accepting face of a solar energy collector of Reference 1, and Reference 5 represents a support post upon which the framing of Reference 2 is attached, and wherein the attachment of the framing of Reference 2 to the support post of Reference 5 is such that it at least allows the ability to adjust the tilt angle of the framing to which the solar energy collector and the solar light optical aligner are attached to achieve different tilt angles relative to the north or south horizon in order to adjust the solar energy collector and the solar optical aligner to achieve a substantially perpendicular alignment between the sun and the sun light facing Fresnel lens of the solar optical aligner and the primary sun light accepting face of the solar energy collector for any north to south seasonal movement of the sun.

FIG. 12 shows a side view of the primary sun light accepting face of a solar energy collector as Reference 1, mounted in a framing shown as Reference 2, with Reference 3 pointing to a side view of an example of the solar light optical aligner of the present invention, and the solar light optical aligner is also mounted to the framing of Reference 2 such that the face of the Fresnel lens of the solar light optical aligner of Reference 3 is parallel to and flush with the primary sun light accepting face of a solar energy collector of Reference 1, and Reference 4 represents a support post upon which the framing of Reference 2 is attached, and wherein the attachment of the framing of Reference 2 to the support post of Reference 4 is such that it at least allows the ability to adjust the tilt angle of the framing to which the solar energy collector and the solar light optical aligner are attached to achieve different tilt angles relative to the north or south horizon in order to adjust the solar energy collector and the solar optical aligner to achieve a substantially perpendicular alignment between the sun and the sun light facing Fresnel lens of the solar optical aligner and the primary sun light accepting face of the solar energy collector for any north to south seasonal movement of the sun, as shown for example by Position A that could represent an example of an optimal tilt angle on a particular date and time in the Summer for a south facing solar energy collector at some point in the northern hemisphere such that rays of sun light are substantially perpendicular to the Fresnel lens face of the solar optical aligner and to the primary sun light accepting face of the solar collector that is parallel to the Fresnel lens face as found by aligning the image of the sun to within the target area of the solar optical aligner, and for example by Position B that could represent an example of an optimal tilt angle on a particular date and time in the Spring or Fall for a south facing solar energy collector at some point in the northern hemisphere such that rays of sun light are substantially perpendicular to the Fresnel lens face of the solar optical aligner and to the primary sun light accepting face of the solar collector that is parallel to the Fresnel lens face as found by aligning the image of the sun to within the target area of the solar optical aligner, and for example by Position C that could represent an example of an optimal tilt angle on a particular date and time in the Winter for a south facing solar energy collector at some point in the northern hemisphere such that rays of sun light are substantially perpendicular to the Fresnel lens face of the solar optical aligner and to the primary sun light accepting face of the solar collector that is parallel to the Fresnel lens face as found by aligning the image of the sun to within the target area of the solar optical aligner.

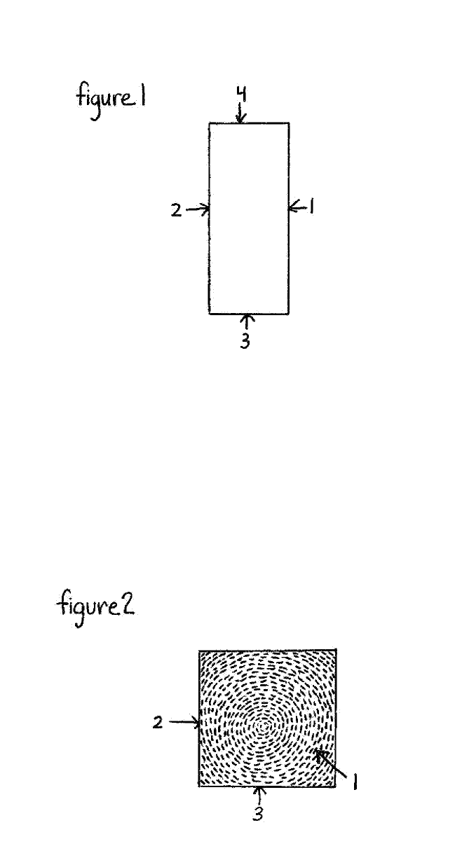

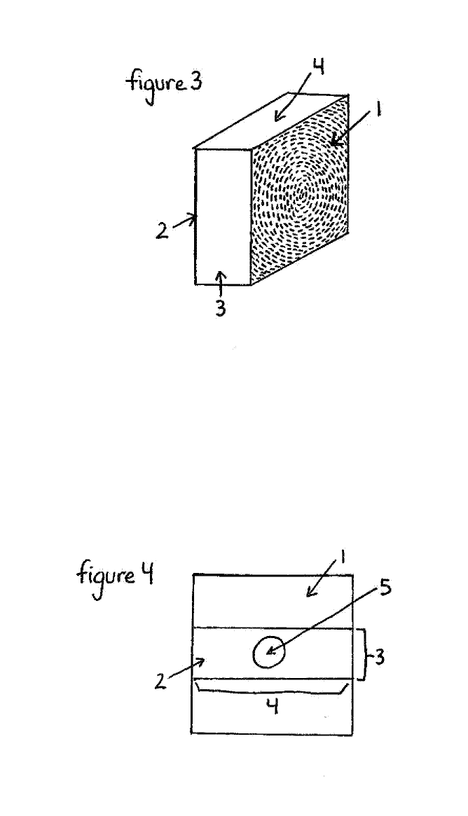

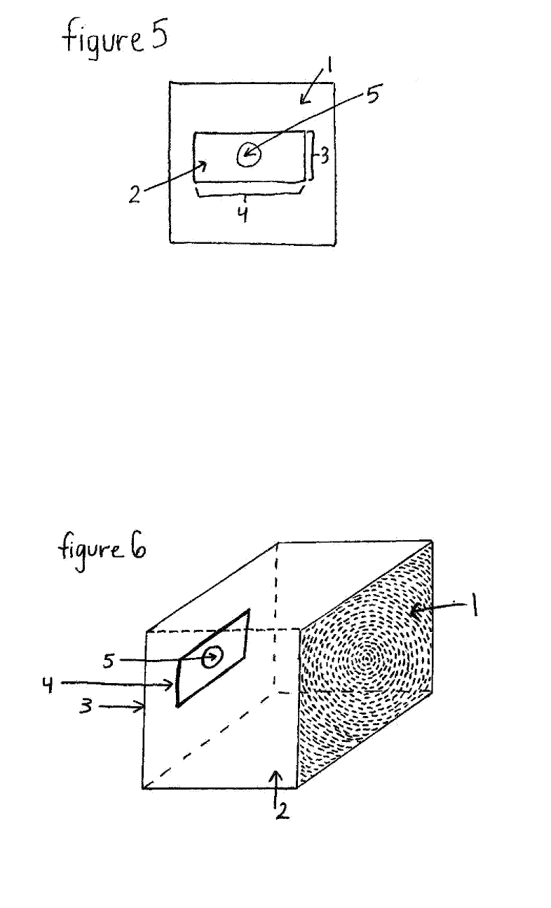

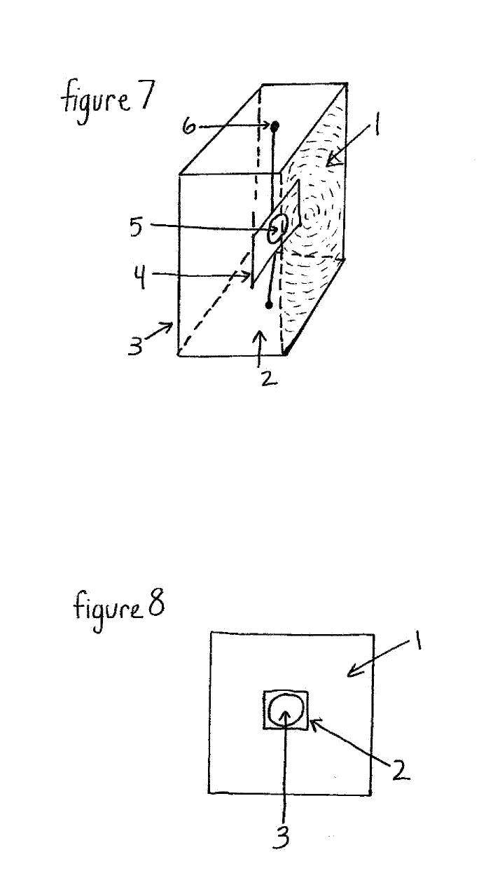

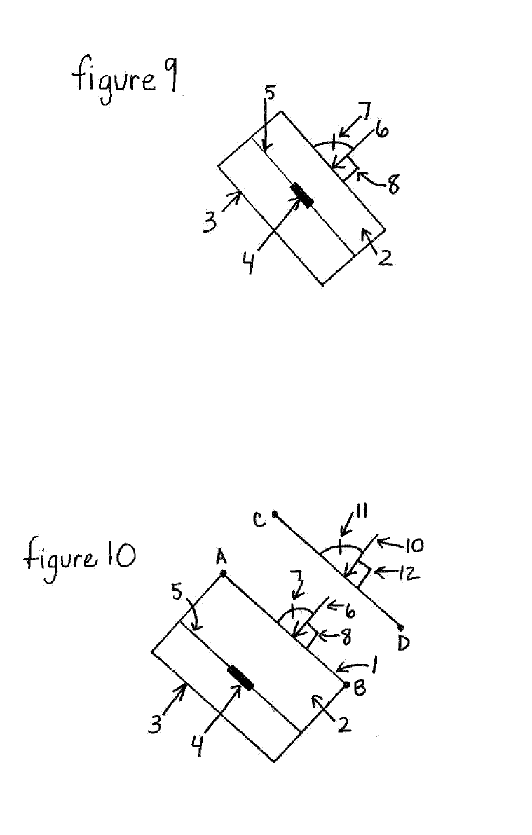

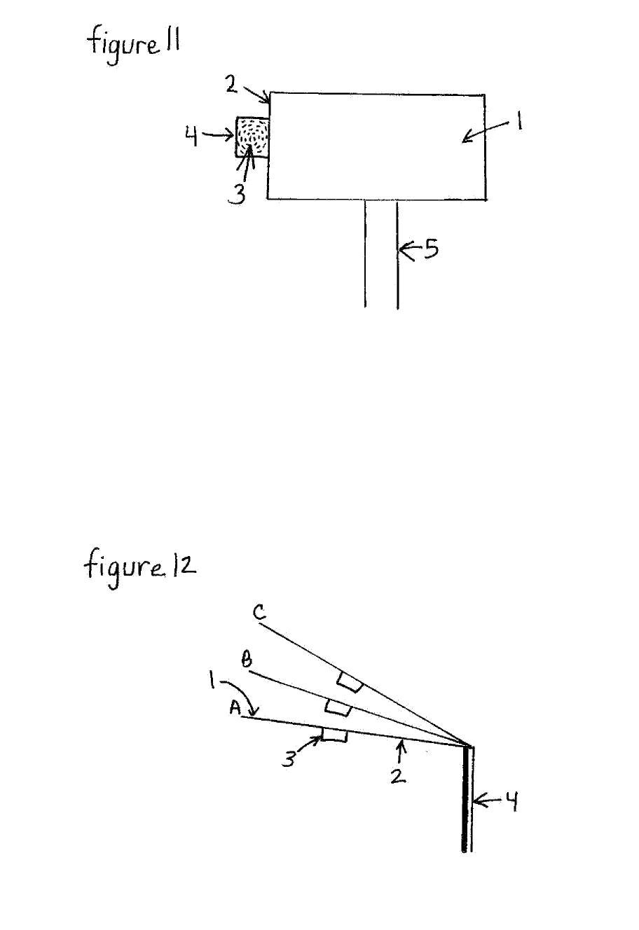

Further novel features and other advantages of the present invention will become apparent from the following description, discussion and the appended claims.

### DESCRIPTION OF EMBODIMENTS

Although specific embodiments of the present invention will now be described, it should be understood that such embodiments are by way of example only and merely illustrative of but a small number of the many possible specific embodiments which can represent applications of the principles of the present invention. Changes and modifications by persons skilled in the art to which the present invention pertains are within the spirit, scope and contemplation of the present invention as further defined in the appended claims. All references cited herein are incorporated by reference as if each had been individually incorporated.

The solar light optical aligner of the present invention comprises of a Fresnel lens face on the sun-facing side of a housing, and a solar light target within the housing. Typically, the Fresnel lens is a square shape with all sides of equal length and a flat top face that faces the sun. The flat top face of the Fresnel lens that faces the sun then represents a planar surface. The dimensions of the Fresnel lens are typically flat-faced squares with each side length being from about 1 cm to about 15 cm to form for example a 1×1×1×1 cm square or a 5×5×5×5 cm square, or each side length can be from about 1 cm to about 10 cm, or from about 2 cm to about 10 cm, or from about 2 cm to about 5 cm. The thickness of the Fresnel lens is typically from about 0.5 mm to about 5 mm. Both the focal length of the Fresnel lens and the distance of the solar light target within the housing can be selected to match the desired size of the Fresnel lens produced image of the sun and size of the target within the solar light optical aligner of the present invention. It is typically desirable to have a focal length that is about 1.25 to 5 times the distance between the Fresnel lens and the solar light target within the housing, or from about 1.5 to about 4 times the distance between the Fresnel lens and the solar light target within the housing, or from about 2 to about 3 times the distance between the Fresnel lens and the solar light target within the housing. By having the target intercept the Fresnel lens image of the sun prior to the focal point, the image of the sun is larger. The larger image of the sun provides a more practical target size than the tiny image of the sun at the focal point, and avoids the high temperatures that are typical at the focal point of a Fresnel lens. The high temperatures that are typical at the focal point of a Fresnel lens can require special materials of construction that are typically unnecessary for most applications of the solar optical light aligner of the present invention. For most applications, the apparatus can determine the optimal tilt between a solar collector and the sun via intercepting the Fresnel lens image of the sun at a distance from the Fresnel lens that is less than the focal point distance from the Fresnel lens. The groove pitch of the Fresnel lens can be from about 0.1 mm to about 10 mm, or from about 0.1 mm to about 5 mm, or from about 0.1 mm to about 3 mm, or from about 0.1 to about 1 mm.

The target within the housing of the present invention is aligned with the center of the Fresnel lens. By aligning the target with the center of the Fresnel lens, the image of the sun produced by the Fresnel lens will hit the target when the sun light is substantially perpendicular to the face of the Fresnel lens. As previously described, aligning the primary sun light accepting face of a solar energy collector so that it is substantially perpendicular to the sun can enable higher solar energy collection efficiency by enabling sun light to impact on the highest area of the collector while achieving very high transmission of solar light into the collector. Typically the dead center of the target is aligned with the dead center of the Fresnel lens for maximum accuracy. Typically, the north to south height of the target is made to be approximately 1 to 1.5 times the height of the image of the sun produced by the Fresnel lens at the particular distance that the target is placed from the Fresnel lens. Typically, the width of the target can be about 1 to about 5 times the width of the image of the sun produced by the Fresnel lens at the particular distance that the target is placed from the Fresnel lens. By utilizing a slightly longer height of the target compared to the image of the sun that would be produced by the Fresnel lens when the sun light rays are perfectly perpendicular to the face of the Fresnel lens of the solar light optical aligner, and a longer width of the target compared to the image of the sun that would be produced by the Fresnel lens when the sun light rays are perfectly perpendicular to the face of the Fresnel lens of the solar optical aligner , the target can accommodate some east to west movement of the sun during the day while still maintaining an alignment to the sun that is substantially perpendicular, e.g. within about 70 to about 110 degree angles from the east to west centerline axis for the sun light rays impacting onto the Fresnel lens face of the solar light optical aligner and subsequently about 70 to about 110 degree angles from the east to west centerline axis for the sun light rays impacting onto the primary sun light accepting face of the solar energy collector. For example, a typical time of day to utilize the solar light optical aligner of the present apparatus is the time of day that corresponds to the highest solar energy availability (solar radiation power density); typically this is approximately from 11 am to 1 pm for a south facing solar energy collector in the northern hemisphere. By utilizing a longer target width, the solar light optical aligner can enable more convenience of use by providing a target width that provides a sufficiently accurate window, for the east to west movement of the sun in the sky, at which to align the solar energy collectors to enable high efficiency solar energy collection. In many cases, solar energy collectors are placed at a fixed east-west orientation, i.e. they are mounted in a fixed position so that the solar energy collectors cannot be adjusted with east to west orientation. However, many solar energy collectors do enable a tilt adjustment to account for the seasonal north to south movement of Earth's tilt. In most cases, a tilt adjustment of about once per month will enable high solar energy collection efficiency in most locations. By utilizing the solar light optical aligner of the present invention, the owner or operator of the solar energy collectors can easily view the image of the sun within the solar optical aligner of the present invention to determine if a tilt adjustment is needed. For a south facing solar energy collection system in the northern hemisphere of the Earth, the hours of approximately 11 am to 1 pm represent the peak solar energy time of the day. For such a south facing solar energy collection system, if the image of the sun is within the target area of the solar optical aligner between the hours of approximately 11 am to 1 pm, then no tilt adjustment is likely to be needed. If the image of the sun is not within the target area of the solar optical aligner between the hours of approximately 11 am to 1 pm, then the tilt of the solar optical aligner is simply adjusted such that the image of the sun is within the target area. The tilt of the solar collectors are then adjusted such that the primary sun light accepting face of the solar collectors is parallel to the Fresnel lens face of the solar optical aligner of the present invention. If the solar optical aligner is conveniently mounted to the same framing device as the solar energy collectors, and the face of the Fresnel lens is parallel to the primary sun light accepting face of the solar energy collectors, then the solar framing device is simply adjusted such that the image of the sun is within the target area of the solar optical aligner of the present invention. The primary sun light accepting face of the solar energy collectors will then be substantially perpendicular to the sun, resulting in the desired high solar energy collection efficiency with high collection area for sun light absorption and high transmittance of sun light. In this example, if the solar energy collectors in the northern hemisphere of the Earth are facing a direction other than south, then the solar optical aligner of the present invention will still be able to easily find the optimal tilt angle for the seasonal north to south change in the tilt of Earth; the owner or operator of the solar energy collector need only adjust the tilt of the solar energy collectors that matches the alignment of the sun's image on the target of the solar light optical aligner of the present invention during approximately the 2 hour window that represents the peak solar energy period (solar radiation power density) according to their east-west orientation of their solar energy collection system. By aligning any particular solar energy collector with a fixed east-west orientation but with an adjustable tilt during approximately the 2 hour window of maximum solar energy (solar radiation power density) for the particular location on earth, east-west orientation of the particular solar collector, pitch of the surface that the solar energy collectors are mounted, and time of year, the daily solar energy output for that particular solar collector can be substantially maximized. For example, if a solar energy collection system faces east to capture the morning sunlight energy, then the 2 hour window of peak solar energy period for that solar energy collector will obviously be sometime in the morning. As long as the face of the Fresnel lens of the solar optical aligner of the present invention is parallel to the primary sunlight accepting face of the solar energy collector, the alignment of the sun's image in the target area of the solar optical aligner will determine the correct tilt for the solar energy collection system during the approximately 2 hour window of maximum solar energy (solar radiation power density) for the orientation and location of the particular solar energy collection system. This is even true for solar energy collection systems that are not mounted on a level surface because the alignment is between the position of the sun and the face of the solar optical aligner of the present invention and subsequently between the position of the sun and the primary sun light accepting face of the solar energy collector, and therefore the concept of a reference to “level” has no relevance. The advantages and convenience of this solar light optical aligner of the present invention to find the correct tilt for high solar energy collection efficiency for a solar energy collection system, regardless of the time of year, east-west orientation of the solar energy collectors, location on earth, and pitch of the surface upon which the solar energy collection system is mounted, is clear.

The housing of the solar light optical aligner can be made of any material that is suitable for handling outdoor environments and the maximum temperature produced by the sun light radiant energy. Many types of plastics can be utilized, especially if they are UV stable. Metals can also be used for the housing. Typically, a box shaped housing geometry is utilized; the sun facing side of the box is the Fresnel lens. Typically, the face of the box that is opposite the Fresnel lens face is also a square that matches the dimensions of the Fresnel lens square. The depth of the sides of the box are typically shorter than the length and width of the Fresnel lens face, and the sides depths are typically equal in length so that the back face of the housing is equidistant from the Fresnel lens face of the box. A typical side depth for the box is 25% to 75% of the Fresnel lens face length, or about 25% to about 50% of the Fresnel lens face length. This typical situation occurs because Fresnel lenses are typically manufactured with a focal length equal to about the Fresnel lens diameter. For a flat-faced, square Fresnel lens, the diameter of the Fresnel lens equals either the length or the width of the square (both values, the length and width, being identical for a square). Therefore by making the side depth of the box-like housing equal to about 25% to about 75% of the Fresnel lens face length, the distance between the Fresnel lens face and the back face of the box will be approximately 25% to about 75% of the typical Fresnel lens focal length. This reduces the chances of any portion of the housing being too close to the Fresnel lens focal point, where high temperatures can be encountered due to the high concentration factor of the sun light that is typical at the focal point of a Fresnel lens. Typically, the two sides of the box-like housing that face east and west are transparent, in order to view the image of the sun on the target within the solar light optical aligner of the present invention. Alternatively the two sides that face east and west could be completely open to the ambient air, i.e. no material is used for the two sides that face east and west. The top and bottom sides of the box-like housing are typically opaque, to help maintain a sharp image of the sun's image within the solar optical aligner of the present invention. An insulating layer can also be placed on the inside of the back face or even on the inside of any of the side faces of the housing, to avoid the chance of the concentrated solar energy from the Fresnel lens causing damage to the housing. The target upon which the Fresnel lens aligns the sun's image can conveniently be placed onto the inside of the back face of the housing, e.g. with a target imprinted onto the inside of the back face of the housing. Alternatively the target could be a separate entity located within the housing, such as a section of pipe, a section of insulation, or any other entity that has the ability to show that sun light is focused onto the target from the Fresnel lens. The target could also be a photon sensitive device that can produce a signal such as a sound, or an electrical output signal to which a control system can receive input from the solar light optical aligner for e.g. making automatic adjustments to an automated sun tracking solar energy collector system. For example, a photon energy measuring device can send an output electrical signal that varies according to the amount of photon energy the device is receiving. For very precise solar light optical alignment for e.g. fully automated sun tracking, the size of the target can be approximately equal to the image of the sun when the sun light rays are perpendicular plus or minus about 5 degrees (e.g. 85 to 95 degrees) to the east to west centerline of the Fresnel lens. For a solar collector with fixed east to west orientation, the size of the target can be approximately equal to the range of the image of the sun when the sun light rays are perpendicular to the east to west centerline of the Fresnel lens plus or minus about 10 degrees (e.g. 80 to 100 degrees), or from about 20 degrees (e.g. 70 to 110 degrees) during an approximate 1 to 2 hour window of maximum solar energy (solar radiation power density) for the particular day of the year, location on earth, and east to west orientation of the solar collector at that particular location on earth. During this approximate 1 to 2 hour window, the north to south height of the image of the sun produced by the Fresnel lens will typically be within about 1.5 times or less the height of the sun's image compared to the height of the sun's image of the sun produced when the sun is perfectly perpendicular to the face of the Fresnel lens, and the north to south height of the target within the housing of the solar light optical aligner would then be set to about 1.5 times or less the height of the image of the sun produced when the sun is perpendicular to the face of the Fresnel lens. During this approximate 1 to 2 hour window, the east to west width of the image of the sun produced by the Fresnel lens can be within about 5 times or less the width of the sun's image compared to the width of the sun's image produced when the sun is perfectly perpendicular to the face of the Fresnel lens, and the east to west width of the target within the housing of the solar light optical aligner would then be set to about 5 times or less the width of the image of the sun produced when the sun is perpendicular to the face of the Fresnel lens. More accurate alignment is achieved when the target is set to about 1 times the width of the sun's image produced by the Fresnel lens when the sun is perfectly perpendicular to the face of the Fresnel lens but requires more time monitoring which is no problem for automated tracking systems, whereas when the target is closer to 5 times the width of the sun's image produced by the Fresnel lens when the sun is perfectly perpendicular to the face of the Fresnel lens is less accurate but offers greater convenience for manual adjustment by enabling the collector to be adjusted at any time during the sun's east to west movement during the approximate 1 to 2 hour window of peak solar energy availability for the particular location, time of year, and east to west orientation of the solar collector. The target's east to west width can be set at anywhere between 1 to about 5 times the width of the sun's image produced by the Fresnel lens when the sun is perfectly perpendicular to the face of the Fresnel lens, to balance accuracy versus convenience for the owner or operator of the solar energy collector. Typically a flat rectangular target shaped target can be utilized. The target is typically equidistant from the Fresnel lens face and parallel to the face of the Fresnel lens in order to easily view the image of the sun on the target and to insure accurate alignment between the image of the sun produced by the Fresnel lens and the target, and thereby obtain accurate alignment between the Fresnel lens face of the solar light optical aligner and the primary sun light accepting face of a solar energy collector. The dead center of the target is typically aligned with the dead center of the Fresnel lens for maximum alignment accuracy. application.

1-21. (canceled)

22. A solar light aligning apparatus comprising:
a Fresnel lens as a sun light facing side of said solar light aligning apparatus;
a housing comprising said Fresnel lens as the sun light facing side of said housing, said housing further comprising at least one side face capable of enabling viewing of the image of the sun produced by said Fresnel lens; and
a target located within said housing upon which an image of the sun produced by said Fresnel lens alignable onto when rays of sun light impacting onto a face of said Fresnel lens are perpendicular relative to said face of said Fresnel lens.

23. The solar light aligning apparatus of claim 22, wherein said Fresnel lens is a square with all four sides equal in length, and said length of each side is selected from a range of 1 cm to 15 cm, and a thickness of said Fresnel lens is selected from a range of 0.5 mm to 5 mm, and a groove pitch of said Fresnel lens is selected from a range of 0.1 to 10 mm, and a focal length of said Fresnel lens is selected from a range of 1.25 to 5 times a distance between an inside wall face of said Fresnel lens and said target located within said housing.

24. The solar light aligning apparatus of claim 22, wherein said target located within said housing has a dead center alignable with a dead center of said Fresnel lens.

25. The solar light aligning apparatus of claim 22, wherein said target is placed onto an inside wall face of said housing.

26. The solar light aligning apparatus of claim 22, wherein said target is suspended inside said housing.

27. A solar light aligning apparatus comprising:
a Fresnel lens as a sun light facing side of said solar light aligning apparatus;
a housing comprising said Fresnel lens as the sun light facing side of said housing, said housing further comprising at least one side face capable of enabling viewing of the image of the sun produced by said Fresnel lens; and
a target region located within said housing upon which an image of the sun produced by said Fresnel lens alignable within when rays of sun light impacting onto a face of said Fresnel lens impact onto said Fresnel lens at an angle range from 80 to 100 degrees relative to an east to west centerline axis of said Fresnel lens face.

28. The solar light aligning apparatus of claim 27, wherein said Fresnel lens is a square with all four sides equal in length, and said length of each side is selected from a range of 1 cm to 15 cm, and a thickness of said Fresnel lens is selected from a range of 0.5 mm to 5 mm, and a groove pitch of said Fresnel lens is selected from a range of 0.1 to 10 mm, and a focal length of said Fresnel lens is selected from a range of 1.25 to 5 times a distance between an inside wall face of said Fresnel lens and said target located within said housing.

29. The solar light aligning apparatus of claim 27, wherein said target located within said housing has a dead center alignable with a dead center of said Fresnel lens.

30. The solar light aligning apparatus of claim 27, wherein said target is placed onto an inside wall face of said housing.

31. The solar light aligning apparatus of claim 27, wherein said target is suspended inside said housing.

32. A solar light aligning apparatus comprising:
a Fresnel lens as a sun light facing side of said solar light aligning apparatus;
a housing comprising said Fresnel lens as the sun light facing side of said housing, said housing further comprising at least one side face capable of enabling viewing of the image of the sun produced by said Fresnel lens; and
a target region located within said housing upon which an image of the sun produced by said Fresnel lens alignable within when rays of sun light impacting onto a face of said Fresnel lens impact onto said Fresnel lens at an angle range from 70 to 110 degrees relative to an east to west centerline axis of said Fresnel lens face.

33. The solar light aligning apparatus of claim 32, wherein said Fresnel lens is a square with all four sides equal in length, and said length of each side is selected from a range of 1 cm to 15 cm, and a thickness of said Fresnel lens is selected from a range of 0.5 mm to 5 mm, and a groove pitch of said Fresnel lens is selected from a range of 0.1 to 10 mm, and a focal length of said Fresnel lens is selected from a range of 1.25 to 5 times a distance between an inside wall face of said Fresnel lens and said target located within said housing.

34. The solar light aligning apparatus of claim 32, wherein said target located within said housing has a dead center alignable with a dead center of said Fresnel lens.

35. The solar light aligning apparatus of claim 32, wherein said target is placed onto an inside wall face of said housing.

36. The solar light aligning apparatus of claim 32, wherein said target is suspended inside said housing.
